(19) United States
(12) Patent Application Publication
(10) Pub. No.: US 2008/0271013 A1
(43) Pub. Date: Oct. 30, 2008

(54) Method for Installing a Computer Operating System through Add-on Disk Image Files

(76) Inventor: Chien-Ming Chu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/045,031

(22) Filed: Mar. 10, 2008

(30) Foreign Application Priority Data
Apr. 30, 2007 (TW) 096115290

(51) Int. Cl. G06F 9/445

(52) U.S. Cl. 717/175

(57) ABSTRACT

A method for reducing file storage area includes duplicating a original disk image file of an operating system to a storage device of a computer, duplicating a plurality of add-on disk image files to the storage device, and installing the original disk image file of the operating system and at least one add-on disk image file to the storage device of the computer. The plurality of add-on disk image files are different language packages, different package specific software or different SKU packages.

### BACKGROUND OF THE INVENTION

1. Field of the Invention

The present invention relates to a method for processing disk image files, and more particularly, to a method for installing an operating system to a computer through add-on disk image files.

2. Description of the Prior Art

Operating systems are communication channels between users and computers. Presently, the most common operating systems include Linux, Windows XP, Windows Vista, OS/2, and NeXStep, etc. Among them, Windows Vista is a new version operating system published by Microsoft, which will have six editions to be directed against different users to offer different choices. At the present day, the Windows series operating systems published by Microsoft own a market share of personal computers to 90%.

Presently, when performing a multi-lingual or multi-SKU operating system installation, the disk image files for each language or each SKU operating system are respectively stored as an individual disk image file. Please refer to FIG. 1. FIG. 1 is a diagram illustrating disk image files of a multi-language or multi-SKU operating system according to the prior art. As shown in FIG. 1, assume that an operating system includes three language editions (such as English, German, and French), and then the operating system is made as three disk image files 120, 130, and 140. A size of each disk image file is 5 GB. The three disk image files 1 20, 1 30, and 140 are stored into a first hard disk 110 of a first computer 100, thus the disk image files 120, 130, and 140 will occupy a disk space of 15 GB. The three disk image files 120, 130, and 140 are uploaded to an image server 150, and then a second computer 160 downloads the three disk image files 120, 130, and 140 from the image server 150 and stores them into a second hard disk 170 through internet. Assume that a downloading speed of the second computer 160 is 0.5 GB/min, thus totally 30 minutes are spent on downloading the three disk image files 120, 130, and 140.

Due to the disk image files for each language or each SKU operating system being respectively stored as an individual disk image file, therefore, these disk image files will occupy huge disk space or waste storage space of the image server. Furthermore, due to the size of these disk image files being too bigger, more and more time is spent for downloading them.

### SUMMARY OF THE INVENTION

The claimed invention provides a method for installing an operating system to a computer through add-on disk image files. The method includes duplicating an original disk image file of an operating system to a storage device of the computer, duplicating a plurality of add-on disk image files to the storage device, and installing the original disk image file of the operating system and at least one add-on disk image file to the storage device of the computer. The method further includes deleting unselected add-on disk image files. The plurality of add-on disk image files are different language packages, different package specific software or different SKU packages.

The claimed invention further provides a method for installing an operating system to a computer through add-on disk image files. The method includes duplicating an original disk image file of an operating system to an image server, duplicating at least two add-on disk image files to the image server, and installing the original disk image file of the operating system and at least one add-on disk image file to the computer. The method further includes downloading the original disk image file of the operating system and at least two add-on disk image files from the image server to a second computer, installing the original disk image file of the operating system and at least one add-on disk image files to the second computer, and deleting unselected add-on disk image files. The add-on disk image files are different language packages, different package specific software or different SKU packages.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating disk image files of a multi-language or multi-SKU operating system according to the prior art.

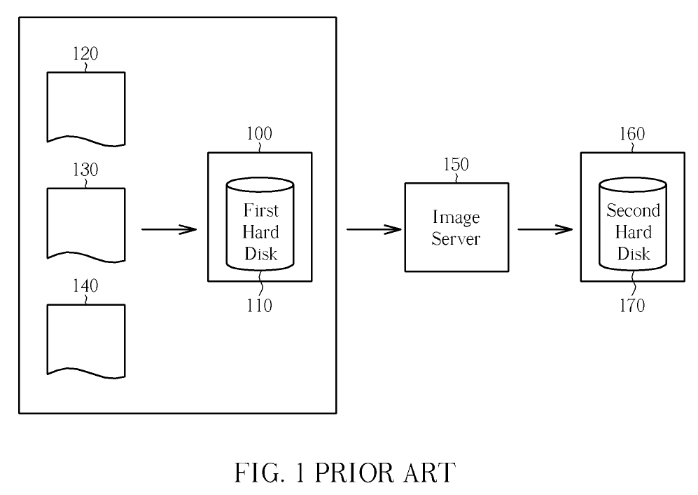

FIG. 2 is a diagram illustrating disk image files of a multi-language or multi-SKU operating system according to an embodiment of the present invention.

FIG. 3 is a diagram of a flowchart illustrating a method for installing an operating system to a computer through add-on disk image files according to a first embodiment of the present invention.

FIG. 4 is a diagram illustrating disk image files of a multi-language or multi-SKU operating system according to another embodiment of the present invention.

FIG. 5 is a diagram of a flowchart illustrating a method for installing an operating system to a computer through add-on disk image files according to a second embodiment of the present invention.

FIG. 6 is a diagram showing how to generate the add-on disk image files in FIG. 2.

### DETAILED DESCRIPTION

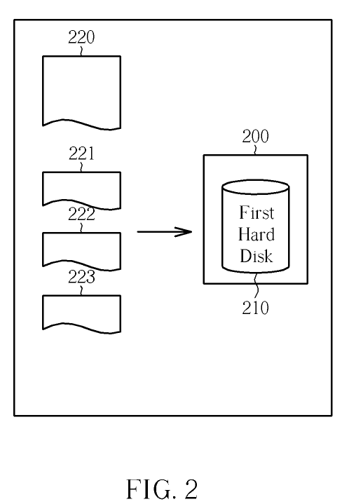

Please refer to FIG. 2. FIG. 2 is a diagram illustrating disk image files of a multi-language or multi-SKU operating system according to an embodiment of the present invention. As shown in FIG. 2, assume that an operating system includes three language editions (such as English, German, and French). At first, an original disk image file 220 of the operating system is produced, and then three add-on disk image files 221, 222, and 223 are produced. A size of the original disk image file 220 is 4 GB and each size of the three add-on disk image files 221, 222, and 223 is 1 GB respectively, whereof the three add-on disk image files 221, 222, and 223 are an English language package, a German language package, and a French language package respectively. The original disk image file 220 and the three add-on disk image files 221, 222, and 223 are stored into a first hard disk 210 of a first computer 200, whereof these image files will occupy a disk space of 7 GB.

In the abovementioned embodiment, the operating system includes Microsoft Windows XP operating system or Microsoft Windows Vista operating system but is not limited to them only, and can be other operating systems. Please note that, the abovementioned add-on disk image files 221, 222, and 223 are merely embodiments for describing the present invention, and in no way should be considered to be limitations of the scope of the present invention. The add-on disk image files 221, 222, and 223 can be different language packages, different language specific software, or different SKU packages. Furthermore, if the operating system further includes more language editions or more SKUs, not only disk spaces but also download time can be saved through the method of the present invention.

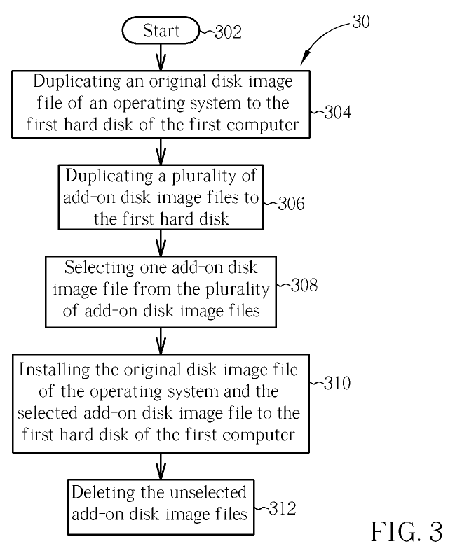

Please refer to FIG. 3. FIG. 3 is a diagram of a flowchart 30 illustrating a method for installing an operating system to a computer through add-on disk image files according to a first embodiment of the present invention. The flowchart 30 includes the following steps:

Step 302: Process start;

Step 304: duplicating an original disk image file of an operating system to the first hard disk 210 of the first computer 200;

Step 306: duplicating a plurality of add-on disk image files to the first hard disk 210;

Step 308: selecting one add-on disk image file from the plurality of add-on disk image files;

Step 310: installing the original disk image file of the operating system and the selected add-on disk image file to the first hard disk 210 of the first computer 200; and

Step 312: deleting the unselected add-on disk image files.

Please cooperate with FIG. 2 for easy illustration. First of all, the original disk image file 220 of the operating system is duplicated to the first hard disk 210 of the first computer 200 (step 304), and then the three add-on disk image files 221, 222, and 223 are duplicated to the hard disk 210 (step 306). Assume that a user wants to select the German language package (the add-on disk image file 222) in step 308. Thus the original disk image file 220 and the add-on disk image file 222 are installed into the first hard disk 210 of the first computer 200 in step 310, and both the English language package (the add-on disk image file 221) and the French language package (the add-on disk image file 223) are deleted from the first hard disk 210 in step 312.

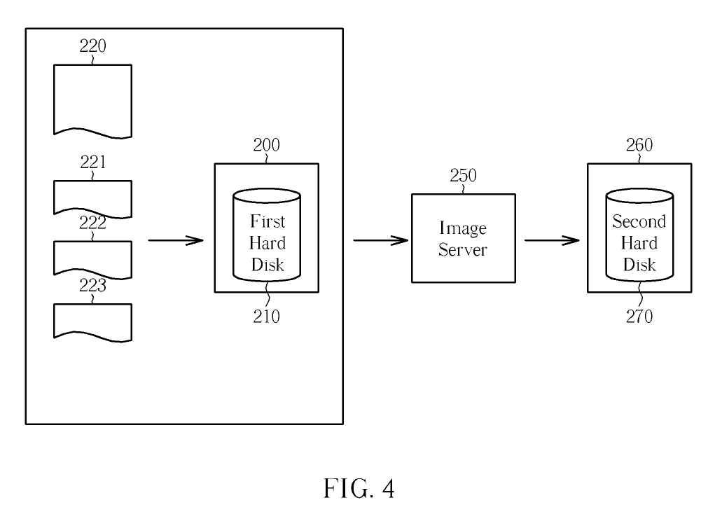

Please refer to FIG. 4. FIG. 4 is a diagram illustrating disk image files of a multi-language or multi-SKU operating system according to another embodiment of the present invention. The difference between FIG. 4 and FIG. 2 is that the original disk image file 220 of the operating system and the three add-on disk image files 221, 222, and 223 are further uploaded to an image server 250 in FIG. 4, whereof these disk image files will occupy a disk space of 7 GB of the image server 250. And then a second computer 260 downloads the original disk image file 220 of the operating system and the three add-on disk image files 221, 222, and 223 from the image server 250 through internet and stores them into a second hard disk 270. Assume that a downloading speed of the second computer 260 is the same as 0.5 GB/min, therefore, 14 minutes in total are spent on downloading these disk image files.

In this embodiment, the abovementioned add-on disk image files 221, 222, and 223 are merely embodiments for describing the present invention, and in no way should be considered to be limitations of the scope of the present invention. The add-on disk image files 221, 222, and 223 can be different language packages, different language specific software, or different SKU packages. Furthermore, if the operating system further includes more language editions or more SKUs, not only disk spaces but also download time can be saved through the method of the present invention.

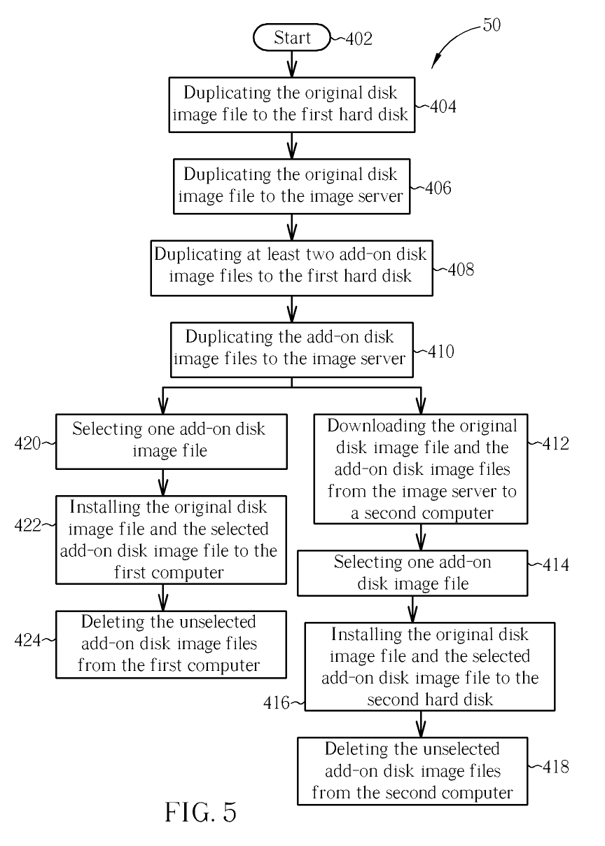

Please refer to FIG. 5. FIG. 5 is a diagram of a flowchart 50 illustrating a method for installing an operating system to a computer through add-on disk image files according to a second embodiment of the present invention. The flowchart 50 includes the following steps:

Step 402: Process start;

Step 404: duplicating the original disk image file 220 of an operating system to the first hard disk 210 of the first computer 200;

Step 406: duplicating the original disk image file 220 of the operating system to the image server 250;

Step 408: duplicating at least two add-on disk image files to the first hard disk 210 of the first computer 200;

Step 410: duplicating the at least two add-on disk image files to the image server 250;

Step 412: downloading the original disk image file 220 of the operating system and the at least two add-on disk image files from the image server 250 to a second computer 260;

Step 414: selecting one add-on disk image file from the at least two add-on disk image files;

Step 416: installing the original disk image file 220 of the operating system and the selected add-on disk image file to the second hard disk 270 of the second computer 260;

Step 418: deleting the unselected add-on disk image files from the second computer 260;

Step 420: selecting one add-on disk image file from the at least two add-on disk image files;

Step 422: installing the original disk image file 220 of the operating system and the selected add-on disk image file to the first computer 200; and

Step 424: deleting the unselected add-on disk image files from the first computer 200.

Please cooperate with FIG. 4 for easy illustration. First of all, the original disk image file 220 of the operating system is duplicated to the first hard disk 210 of the first computer 200 (step 404), and the original disk image file 220 of the operating system is stored into the image server 250 (step 406). And then the three add-on disk image files 221, 222, and 223 are duplicated to the hard disk 210 (step 408), and the three add-on disk image files 221, 222, and 223 are stored into the image server 250 (step 410). In step 412, the original disk image file 220 of the operating system and the three add-on disk image files 221, 222, and 223 are downloaded from the image server 250 by the second computer 260. Assume that a user of the second computer 260 wants to select the German language package (the add-on disk image file 222) in step 414. Thus the original disk image file 220 and the add-on disk image file 222 are installed into the second computer 260 in step 41 6, and both the English language package (the add-on disk image file 221) and the French language package (the add-on disk image file 223) are deleted from the second computer 260 in step 418. On the other hand, assume that a user of the first computer 200 wants to select the German language package (the add-on disk image file 222) in step 420. Thus the original disk image file 220 and the add-on disk image file 222 are installed into the first computer 200 in step 420, and both the English language package (the add-on disk image file 221) and the French language package (the add-on disk image file 223) are deleted from the first computer 200 in step 424.

Please refer to FIG. 3 and FIG. 5. The difference between the flowchart 50 in FIG. 5 and the flowchart 30 in FIG. 3 is that the flowchart 30 merely produces the original disk image file 220 and the three add-on disk image files 221, 222, and 223 for supplying usage for the first computer 200, but the flowchart 50 further uploads the original disk image file 220 and the three add-on disk image files 221, 222, and 223 to the image server 250 through internet for supplying usage for other computers (such as the second computer 260).

Please note that, the flowchart 30 and the flowchart 50 are merely practical embodiments of the present invention, and in no way should be considered to be limitations of the scope of the present invention. Moreover, the sequence of the steps in FIG. 3 and FIG. 5 can be adjusted depending on different situations, and is not limited to the abovementioned sequence. For example, the steps 406 and 410 can be omitted by the first computer 200, and the steps 418 and 420 can be directly executed for selecting and installing the desirous add-on disk image file. Or the first computer 200 can execute the steps 418 and 420 after downloading the original disk image file 220 and the three add-on disk image files 221, 222, and 223 from the image server 250 (after executing the step 412).

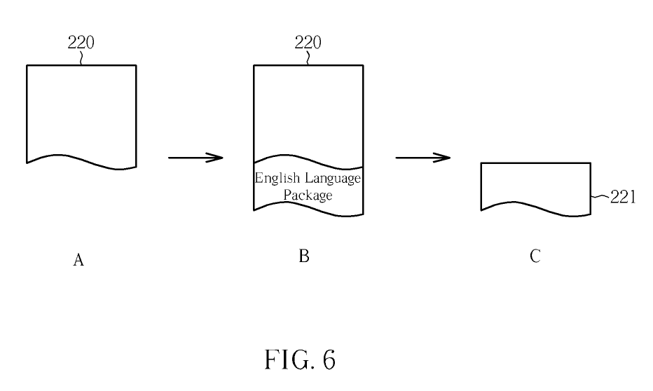

Please refer to FIG. 6. FIG. 6 is a diagram showing how to generate the add-on disk image files 221, 222, and 223 in FIG. 2. At first, the original disk image file 220 is produced (provided with a file size of 4 GB), and then the English language package is installed on the original disk image file 220. Finally, the add-on disk image file 221 (provided with a file size of 1 GB) is produced. The abovementioned steps are repeated to generate the add-on disk image file 222 and the add-on disk image file 223. Please note that, if the operating system further includes more language editions or more SKUs, more and more add-on disk image files can be produced through repeating the abovementioned steps.

The abovementioned embodiments are presented merely for describing the present invention, and in no way should be considered to be limitations of the scope of the present invention. The abovementioned operating system are not limited to Microsoft Windows XP operating system or Microsoft Windows Vista operating system only, and can be other operating systems. The add-on disk image files 221, 222, and 223 can be different language packages, different language specific software, or different SKU packages, but are not limited to them only. Furthermore, the amount of the add-on disk image files is not restricted to three merely and can be expanded to a plurality, which depends on practical applications. Moreover, the flowchart 30 and the flowchart 50 are merely practical embodiments of the present invention, and in no way should be considered to be limitations of the scope of the present invention, whereof the sequence of the steps in FIG. 3 and FIG. 5 can be adjusted depending on different situations and is not limited to the abovementioned sequence. The above descriptions are merely preferred embodiments of the present invention, and other modified designs obeying the spirit of the present invention are possible and should also fall into the scope of the present invention.

In summary, the present invention provides a method for installing an operating system to a computer through add-on disk image files. Due to the same section of a multi-lingual or multi-SKU operating system being stored as the original disk image file 220 and different sections of the multi-lingual or multi-SKU operating system being stored as a plurality of add-on disk image files (such as 221, 222, and 223) through the present invention, compared with the prior art, the multi-lingual or multi-SKU operating system is stored as several disk image files (such as 120, 130, and 140). Therefore, not only disk spaces but also download time can be saved through the disclosed method. Furthermore, if the operating system further includes more language editions or more SKUs, more and more disk spaces and download time can be saved through the method of the present invention.

Those skilled in the art will readily observe that numerous modifications and alterations of the device and method may be made while retaining the teachings of the invention.

What is claimed is:

1. A method for installing an operating system to a computer through add-on disk image files, the method comprising:
duplicating an original disk image file of an operating system to a storage device of the computer;
duplicating a plurality of add-on disk image files to the storage device; and
installing the original disk image file of the operating system and at least one add-on disk image file to the storage device of the computer.

2. The method of claim 1 further comprising:
deleting unselected add-on disk image files.

3. The method of claim 2, wherein the step of deleting the unselected add-on disk image files comprises deleting the unselected add-on disk image files from the computer.

4. The method of claim 1, wherein the operating system comprises Microsoft Windows XP operating system.

5. The method of claim 1, wherein the operating system comprises Microsoft Windows Vista operating system.

6. The method of claim 1, wherein the plurality of add-on disk image files are different language packages.

7. The method of claim 1, wherein the plurality of add-on disk image files are different language specific software.

8. The method of claim 1, wherein the plurality of add-on disk image files are different SKU packages.

9. A method for installing an operating system to a computer through add-on disk image files, the method comprising:
duplicating an original disk image file of an operating system to an image server;
duplicating at least two add-on disk image files to the image server; and
installing the original disk image file of the operating system and at least one add-on disk image file to the computer.

10. The method of claim 9 further comprising:
downloading the original disk image file of the operating system and at least two add-on disk image files from the image server to a second computer.

11. The method of claim 10 further comprising:
installing the original disk image file of the operating system and at least one add-on disk image files to the second computer; and
deleting unselected add-on disk image files.

12. The method of claim 11, wherein:
installing the original disk image file of the operating system and at least one add-on disk image file to the computer comprises installing the original image file of the operating system and at least one selected add-on disk image file to the computer; and
deleting the unselected add-on disk image files comprises deleting the unselected add-on disk image files from the second computer.

13. The method of claim 9, wherein the operating system comprises Microsoft Windows XP operating system.

14. The method of claim 9, wherein the operating system comprises Microsoft Windows Vista operating system.

15. The method of claim 9, wherein the add-on disk image files are different language packages.

16. The method of claim 9, wherein the add-on disk image files are different language specific software.

17. The method of claim 9, wherein the add-on disk image files are different SKU packages.
